(19) United States
(12) Patent Application Publication
(10) Pub. No.: US 2003/0028421 A1
(43) Pub. Date: Feb. 6, 2003

(54) Allowance calculation program

(76) Inventor: Seiji Kobayashi, Kanagawa (JP)

Correspondence Address: WENDEROTH, LIND & PONACK, L.L.P., 2033 K STREET N. W., SUITE 800, WASHINGTON, DC, 20006-1021, US

(21) Appl. No.: 09/917,635

(22) Filed: Jul. 31, 2001

(51) Int. Cl. G06F 17/60

(52) U.S. Cl. 705/11

(57) ABSTRACT

Providing an allowance calculation program, which is processed to compute the allowance by matching a value calculation processing operation to the total allowance and taking not only the pertinent term valuation but also the past valuation result into considerations so as to stringently relate stringent personal valuation result to the corresponding value and be able to obtain the valuatee's agreement.

The allowance calculation program is processed with a personal computer for reflecting the computer-processed personal valuation result on the calculation of allowances such as the wage based on job valuation, the bonus and the annual salary. The allowance is preliminarily set for each of personal valuation subject groups such as those of the same classes and kinds, and for each valuatee the values of the valuation mark based on the personal valuation as ability-wise index, the seniority-wise index such as the basic salary and the past allowance as past valuation result are inputted to the personal computer for processing to calculate the allowance to be paid to each valuatee.

### BACKGROUND OF THE INVENTION

1. Background of the Invention

This invention relates to allowance calculation programs, which are used for allowance calculation in labor management personal valuation in projects and like legal groups and permit fair calculation of wages based on job evaluation, bonuses, annual salaries and so forth from results of fair personal valuations and predetermined total amounts of payment.

2. Prior Art

In organizations running profit-making businesses, the labor costs occupy a great proportion of the organization maintenance expenses. Therefore, such treatments as the wages based on job evaluation and bonus that are allotted from the limited expense resources should be matched to the levels or degrees of contribution to the organization constituted by the individual members. If this is not done so, it results in unsound cost increases, making it impossible to maintain and develop businesses. In addition, treatments having no bearing on the contribution and contradictory treatments lose the morale of the receiving side, and in this respect they again tend to put the organization maintenance in danger. For the above reasons, fair and agreeable personal valuation is desired.

The personal valuation is done by setting a plurality of valuation items matched to the duty and a weight (or weighting) for each item, and it is done in three to five ranks in each item. As the overall valuation mark of each valuatee, the obtained value is not a step-wise or integral value such as 3, 4 or 5, but includes a fraction.

Meanwhile, as for the pay corresponding to the mark, a step-wise wage table is set in ranks or grades. For this reason, the valuation mark including a fraction is irrationally put into either one of, for instance, five ranks on the basis of vague judgment. Therefore, even if the personal valuation standards and pay ranks or grades are laid open, vague and unclear processing is present in connection with how the valuation result is reflected on the job evaluation-based wage and bonus of each valuatee. It is thus impossible to disclose the contents and particulars of the valuation result in a form that is agreeable to the valuatee, that is, the valuatee is difficultly agreeable with the relation between the valuation of his or her own valuation and the corresponding value.

In such personal valuation as one, which adopts a multisided valuation system or the like and is performed in a method of such high open-laying property and agreeability as to convey the result to the valuatee in such a manner that the numerical value obtained as the result is considered in a mathematically stringent relation to the job valuation-based wage, bonus and so forth, an ideal ability-basis organization management. In this case, however, many organizations encounter a problem of the magnitude of the difference between the values heretofore piled up by the conventional seniority system treatments and those computed in the ability system.

More specifically, quick transition from the seniority system to the ability system results in the generation of persons who are deemed to receive greatly increased pays while also generating those who are deemed to receive greatly reduced pays unless the resources are expanded. Such a quick transition to the ability system may result in confusion of the organization and loss of capable men. For this reason, in many cases gradual transition from the seniority-wise system to the ability-wise system is required, and establishment of a clear numerical value processing method, which permits laying open the valuation contents to the valuatees as well, has been demanded.

### SUMMARY OF THE INVENTION

The invention has an object of providing an allowance calculation program, which permits valuatee's agreement to be obtained with consideration of the result of stringently performed personal valuation in stringent relation to the corresponding value, and specifically permits value calculation operation matched to the total allowance with the seniority- or ability-wise degree adjusted by consideration of the degree of reflection of the result of not only the valuation of the pertinent term but also the past valuation result in a given proportion.

According to the invention, the allowance are calculated by using formulas, in which the numerical values of a valuation mark as ability-wise index, a seniority-wise index such as the basic allowance and a preceding term bonus as past valuation result are incorporated as basic variables concerning each valuatee, and which also include constants for adjusting the influence of the three variables on the allowance calculation. The calculated numerical value allowances are matched to a predetermined total allowance. The constants which are determined by the calculation process are calculated whenever the process is performed. The calculated allowance data is laid open to the valuatee. Process programs for the above process operations are built up to permit the constant setting, calculation and graphic display of the result to be readily done on the display screen of a program-processing computer.

### BRIEF DESCRIPTION OF THE DRAWINGS

FIG. 1 is a flow chart illustrating the routine of executing the program according to the invention;

FIG. 2 is a view showing a display configuration example of a series of processes of constant setting, calculation command and calculation result display in the program processing according to the invention;

FIG. 3 is a graph showing valuation mark Tj in the program according to the invention;

FIG. 4 is a graph showing reference allowance Kj as seniority index in the program according to the invention;

FIG. 5 is a graph showing the combination of valuation mark Tj and reference allowance Kj in the program according to the invention;

FIG. 6 is a graph showing preceding term allowance Zj as past valuation result in the program according to the invention;

FIG. 7 is a graph showing allowance when constant Sh in the program according to the invention is set to “1”; and

FIG. 8 is a graph showing allowance when constant Sn in the program according to the invention is set to “0.5”.

### DETAILED DESCRIPTION OF THE PREFERRED EMBODIMENTS

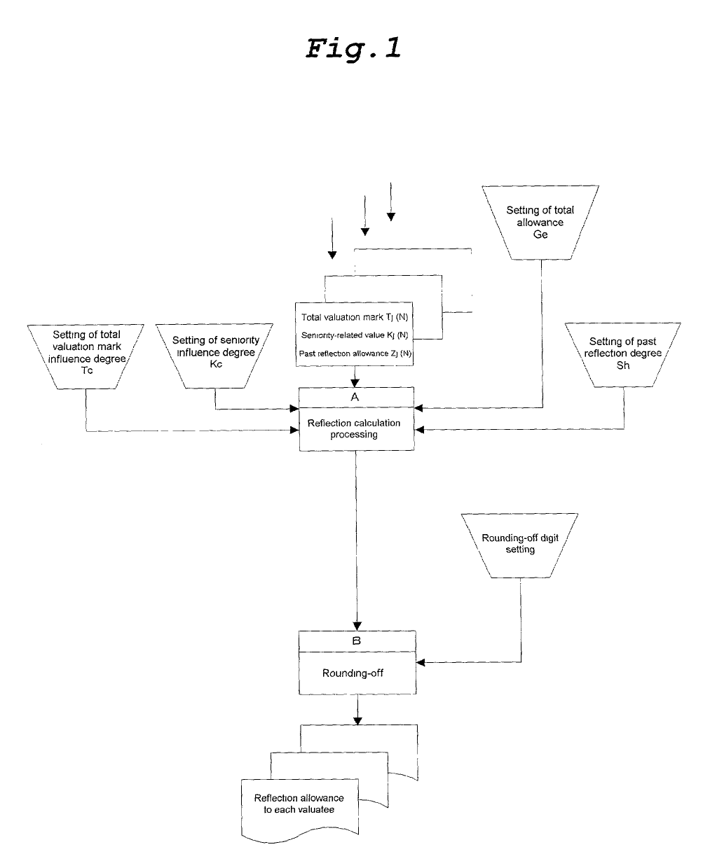

FIG. 1 shows a process routine of calculating the allowance of each valuator, which such personal valuation data as the wave based on job valuation, the result-based bonus, the annual salary and so forth, ability-wise data, are reflected on. According to the invention, such allowances as the wage based on valuation, the bonus, the annual salary and so forth that are to be paid to each valuatee (N), are calculated such that three numerical value data, i.e., overall valuation mark Tj (N) as personal valuation data obtained by pertinent term multisided valuation of the valuatee (N), seniority-based value Kj (N) as amount of allowance item related to the age or continuous service years or amount corresponding to wage model line corresponding to the continuous service years for each job class and past allowance Zj (N), i.e., preceding term bonus, preceding term annual salary, preceding term wage based on job valuation, etc., are used as variables. (In this embodiment, the term “allowance” is used as general term of value such as salary, wage based on job valuation, bonus, etc.)

The following formula 1 is the basic calculation formula of this program for determining the tentative allowance to the valuatee (N) from the product of the overall valuation mark Tj (N) as ability-wise variable and the seniority-related value Kj (N) as seniority-wise variable. At this item, the degrees of influence adjustment constant Kc of the seniority-related value and influence degree adjustment constant Tc of the overall valuation mark are adjusted by adjusting these constants.

(Formula 1)

HNjp (N)=(Kj (N)−Kc) (Tj (N)−Tc)

HNjp (N): tentative allowance to the valuatee (N)

Kj (N): seniority-related value of the valuatee (N)

Tj (N): overall valuation mark of the valuatee (N)

Kc: influence degree adjustment constant of the seniority-related value

Tc: influence-degree adjustment constant of the overall valuation mark

Allowance calculation constant Xc which is obtained from the following formulas 2 and 3, relates the tentative allowance to the total allowance of each group, such as groups of the same job classes and those of the same job kinds, as subject of the personal valuation. The formula 4 incorporating these figures represents the allowance to each valuatee as derived from the total allowance.

(Formula 2)

ToHn=ΣHNjp (N)

ToHn: Sum of the tentative allowances to all the valuatees according to the formula 1.

(Formula 3)

Xc=Ge/ToHn

Ge: total allowance

Xc: Allowance calculation constant

(Formula 4)

HNj (N)=(Kj (N)−Kc) (Tj (N)−Tc) Xc

HNj (N): allowance to the valuatee (N)

The allowance can be given by the formula 4 in the case when determining it from the sole pertinent term, valuation result. On this value, however, variations of the valuation result data of each term are directly reflected. In the calculation of such allowance as the wage based on job valuation, work places and organizations are present, in which it is not desired to increase the variations. Accordingly, where it is judged that a problem resides in the reliability of the valuation for the sole pertinent term, it is an effective selection branch to incorporate the valuation result up to the preceding term for the calculation. The following formula 7 represents this method of calculation, and the following formulas 5 and 6 represent calculation of constants involved.

(Formula 5)

ToZn=ΣZj (N)

Zj (N): past allowance to the valuatee (N)

ToZn: sum of past allowances Zj to all the valuatees

(Formula 6)

A=Ge/ToZn

A: Ratio of total allowance to the sum of past allowances Zj to all the valuatees

(Formula 7)

HNj (N)=Zj (N) A+(((Kj (N)−Kc) (Tj (N)−Tc)Xc)−Zj (N) A) Sh

Sh: reflection degree adjustment constant (0 to 1) for setting the degree of reflection of the past allowance Zj (N) on the tentative allowance HNjp (N)

In the formula 4, the seniority-related value Kj (N) of the valuatee (N) is unnecessary in the cases of work places and organizations, in which no seniority-wise data is incorporated in the allowance calculation. In such cases, the following formula 8 is used as calculation formula. The result allowance HNj (N) is substituted into the formula 7.

(Formula 8)

HNj (N)=Kc (Tj (N)−Tc) Xc

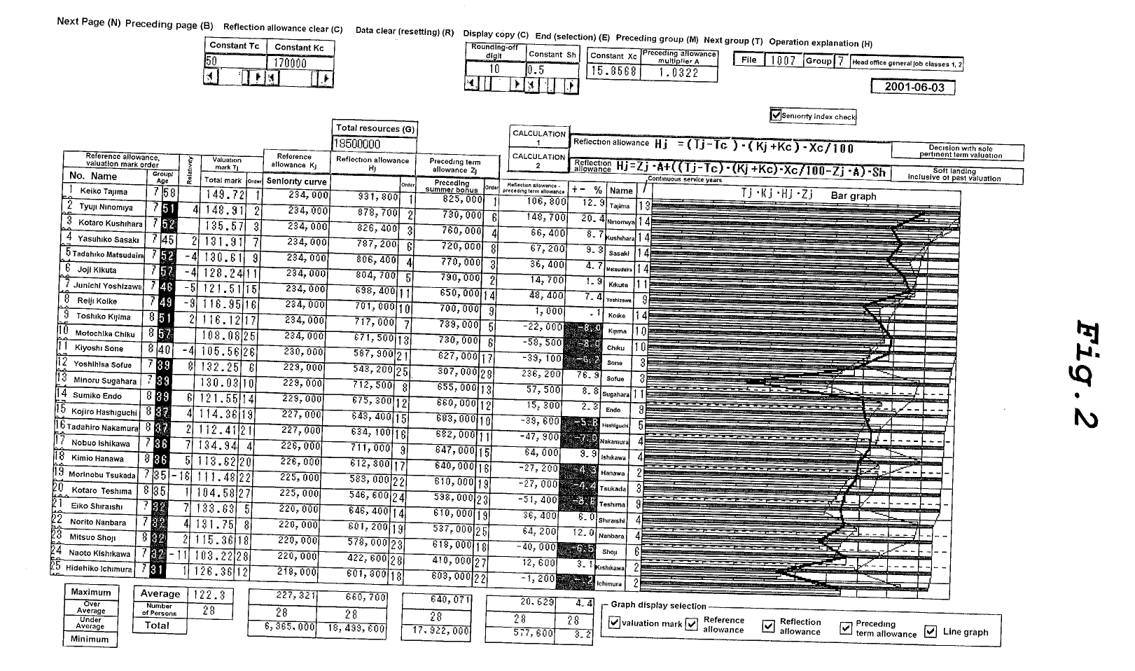

FIG. 2 is a view showing a display configuration example of a series of processes of constant setting, calculation command and calculation result display in the program processing to execute the calculation. For the total valuation mark Tj, the seniority-related reference value Kj (N) and the preceding term value Zj (N) as past allowance to the valuatee (N), given values are selected from a preliminarily registered master file and displayed on the display screen.

By taking off the “SENIORITY-WISE” check shown in FIG. 2 and selecting the value calculation totally independent of the seniority system, the same value is set for all the valuatees in the column of the seniority-related value Kj (N)

In order to increase the influence of the “VALUATION MARK Tj” as ability-wise index, a plus value is entered in the frame of the “CONSTANT Tc”. In this case, the maximum value is the minimum value of the valuation mark Tj. To reduce the influence, on the other hand, a minus value is set. In this case, no limitation is imposed on the minus value.

In order to increase the influence of the “REFERENCE VALUE Kj” as seniority-wise index, a plus value is entered in the frame of the “CONSTANT Kc”. In this case, the maximum value is the minimum value of the reference value Kj. To reduce the influence, on the other hand, a minus value is set. In this case, no limitation is imposed on the minus value.

To set the total allowance, the amount value is entered in the frame of the “TOTAL RESOURCES G”. The calculated value is displayed in the column of the “ALLOWANCE Hj”. To round off the value in a given digit, the digit value is entered in the frame of the “ROUNDING-OFF”. As for the degree of influence of the “PRECEDING TERM ALLOWANCE Zj” on the allowance Hj as past valuation result value, a given value in a range of 0 to 1 is entered as the “CONSTANT Sh”. This value represents the allowance ratio of the preceding term valuation result. When entered value is 1, the calculation is done on the basis of the sole pertinent term valuation, and the past valuation result is ignored. When the entered value is 0, the allowance Hj is the value of the same ratio as the “PRECEDING TERM ALLOWANCE Zj”, and the sum is the value entered in the frame of the “TOTAL RESOURCES G”. It is to be understood that the value set in the frame of the “ROUNDING-OFF” results in error generation, that is, an error in such range is generated.

As for the allowance calculation without any relation to the “PRECEDSING TERM ALLOWANCE Zj”, the calculation in the formula 4 is executedby depressing the “CALCULATION 1” switch. The calculation result is written and displayed in the frame of the allowance Hj to each valuator, and is also displayed in the graph of that value. Furthermore, constant Xc which is derived under this condition is displayed.

As for the allowance calculation involving the “PRECEDING TERM ALLOWANCE Zj”, the calculation of the formula 7 is executed by depressing the “CALCULATION 2” switch. The calculation result is written and displayed in the frame of the allowance Hj to each valuator, and is also displayed in the graph of that value. Furthermore, constants Xc and A which are derived under the preset condition are displayed.

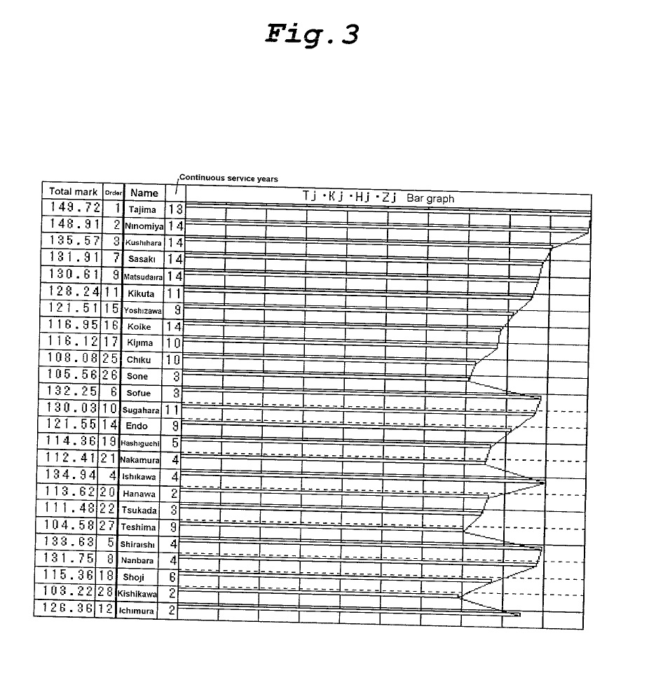

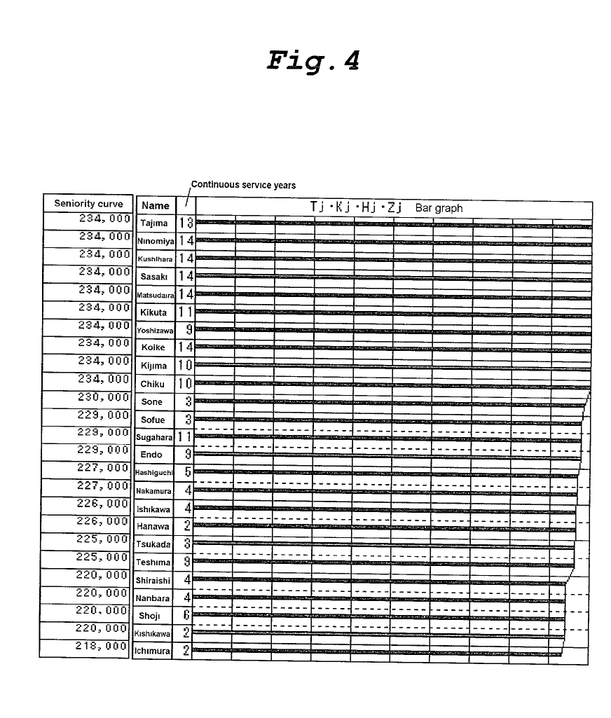

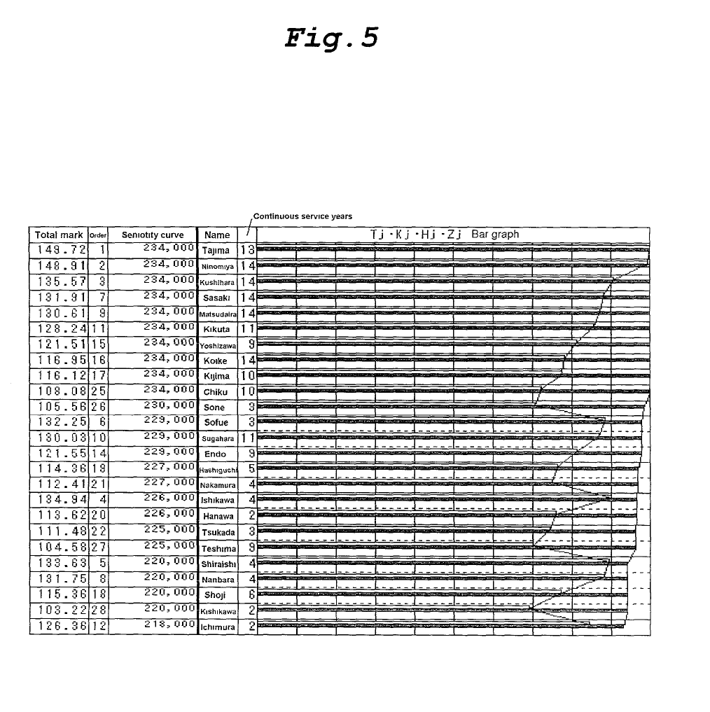

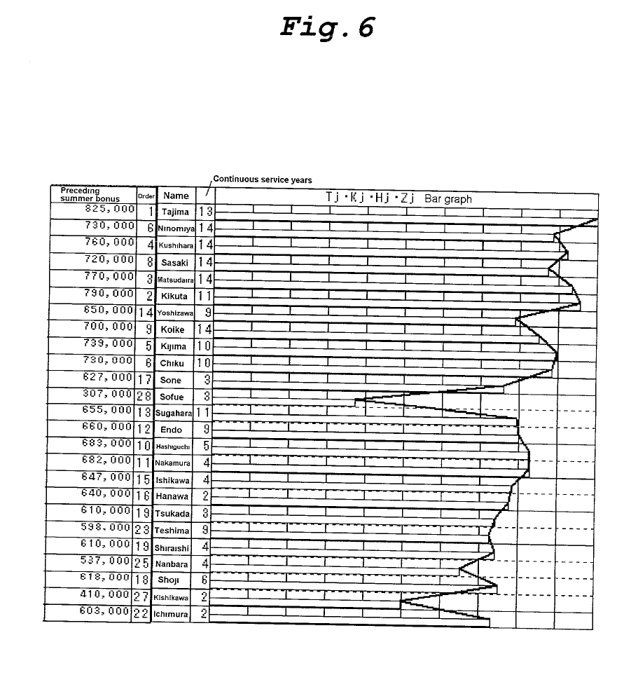

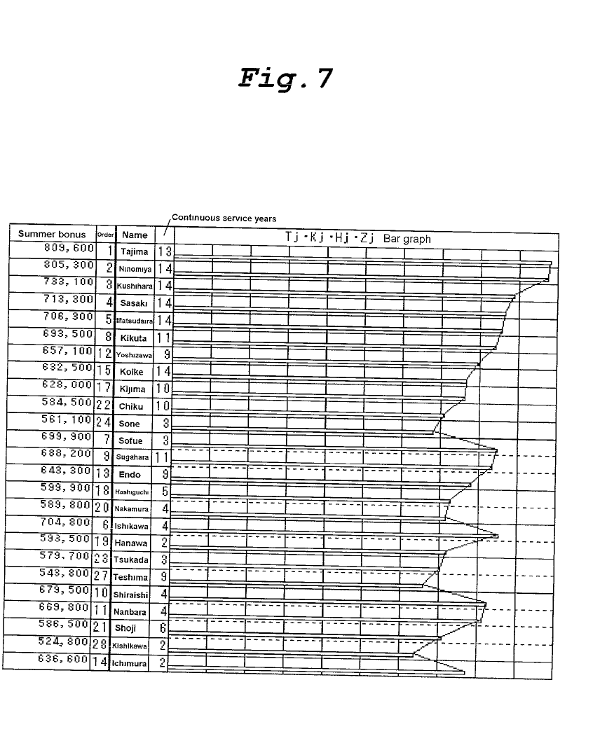

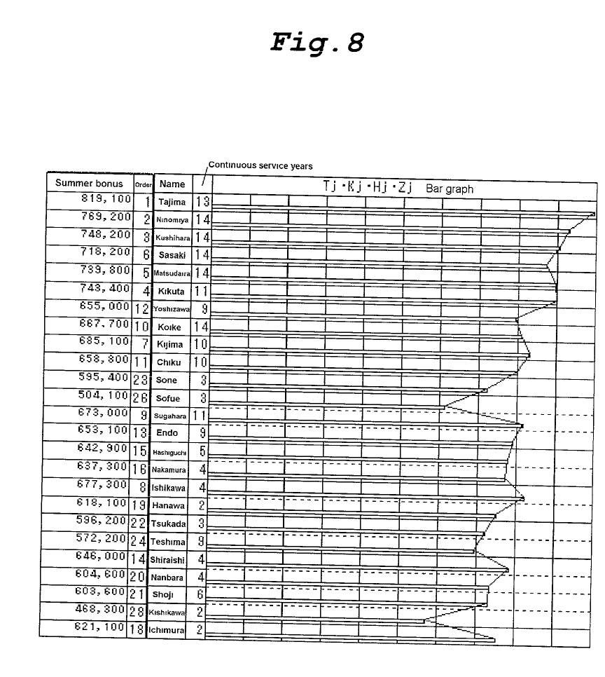

FIG. 3 shows examples of the valuation mark Tj and graphs thereof. FIG. 4 shows examples of the reference value Kj as seniority-wise index and graphs thereof. FIG. 5 shows Tj and Kj in combination. FIG. 6 shows examples of the preceding term value Zj as past valuation result and graphs thereof. FIG. 7 shows the result of calculation executed by setting the constants related to the three basic variables, that is, setting the constants To and Kc to 0, the total allowance G to ¥18,000,000, the rounding-off digit to 10 and the constant Sh to 1. FIG. 8 is the calculation result in the case when the constant Sh is set to 0.5. (It will be understood that regarding the setting of the constants To, Kc and Sh, the influence degrees of these constants can be eliminated by setting 0 as these constants in the formulas using these constants, while they can be set independently by appropriately setting values other than 0 as these constants. In other words, all the three constants may not be used or set appropriately.)

When the adequate allowances are calculated by setting the constants, the formulas and constants that are used are laid open to the valuatees. Each valuatee thus can calculate his or her own allowance from the valuation result and the formulas and constants used. The agreeability and the open-laying property of the valuation thus can be enhanced.

As has been shown, the allowance calculation program according to the invention permits logically distributing the allowance amount as estimate of the labor costs to individual valuatee groups by taking the valuation marks, the seniority index and past valuation result into consideration. In addition, by laying open the valuation mark together with the formulas and constants used to the valuatees, it is possible to enhance the agreeability of the personal valuation. Furthermore, the program permits stringent application of figures and automation of processing to convert the final decision in the personal valuation to a logical and efficient form.

Even if ability-wise valuation reflection is in practice, depending on organizations the members thereof are always moved, leading to changes in the combination of the valuators and valuatees. In such organizations, it is difficult for the valuating side to carry out the confident valuation in a short period of time, and also for the valuatees the valuation result is always subject to changes with valuator changes. According to the invention, it is possible to absorb such changes while making use of the main flow of valuation in time series.

As has been described in the foregoing, the allowance calculation program according to the invention is processed with a personal computer, and permits reflection of the computer-processed personal valuation result on the allowances such as wages based on job valuation, bonuses and annual salaries. Specifically, the total allowances are preliminarily set for each of the personal valuation subject groups such as groups of the same job classes and kinds, and for each valuator the values of the valuation mark based on the personal valuation as the ability-wise index, the seniority-wise index such as basic allowance and the past allowance as past valuation result and so forth, are inputted to the personal computer for processing operation to compute the allowance of each valuatee. Thus, it is possible to eliminate any vague and unclear process in the course of calculation, in which the valuation result is reflected on the allowance of each valuatee. It is also possible to lay open the contents and particulars of the calculation course to the valuatee, while ensuring fair and agreeable calculation of the allowance to be paid to each valuatee.

In addition, in the calculation of the allowance to be paid to each valuatee in an allowance range of each of predetermined personal valuation subject groups, adjustment constants for adjusting the degree of influence on the final result of valuation are added to the values of the valuation mark as ability-wise index, the seniority-wise index such as the basic allowance, the past allowance as past valuation result and so forth. Thus, it is possible to freely set the degree of gradual transition from the seniority-wise system to the ability-wise system. It is also possible to absorb changes in the valuation result values for each term of the ability-wise reflection personal valuation.

Furthermore, with the allowance calculation program according to the invention, in order to obtain reflection of the personal valuation result on the calculation of the allowances such as the wage based on job valuation, the bonus, the annual salary and so forth, the personal computer is programmed such that it functions as a first computing means for obtaining the product of the total valuation mark of each valuatee in the personal valuation and the seniority-related value related to the age, the continuous service years and so forth of each valuatee, a second computing means for calculating the tentative allowance based on the sole pertinent term personal valuation by multiplying the product obtained by the first computing means by the allowance calculation constant obtained by dividing the total allowance for each of predetermined personal valuation subject groups by the sum of the overall valuation marks, a third computing means for calculating the pertinent term allowance change by multiplying the difference between the tentative allowance and the past allowance by the ratio between the past total allowance and the pertinent term total allowance, and a fourth computing means for calculating the allowance for each valuatee by adding the pertinent term allowance change to the past total allowance. Thus, it is possible to eliminate any vague or unclear process and obtain fair and agreeable calculation of the allowance to be paid to each valuatee.

What is claimed is:

1. An allowance calculation program to be processed with a personal computer for reflecting computer-processed personal valuation result on the calculation of allowances such as the wage based on job valuation, the bonus, the annual salary and so forth, wherein the total allowance is preliminarily set for each of personal valuation subject groups such as those of the same job classes and job kinds, and the values of valuation mark of each valuatee based on the personal valuation as ability-wise index, seniority-wise index such as the basic allowance, past allowance as past valuation result and so forth are inputted to the personal computer for processing to calculate the allowance to be paid to each valuatee.

2. The allowance calculation program according to claim 1, wherein in the calculation of the allowance top be paid to each valuatee in an allowance range of each of predetermined personal valuation subject group, adjustment constants for adjusting the degree of influence on the final result of valuation are added to the values of valuation mark as ability-wise index, the seniority-wise index such as the basic allowance, the past allowance as past valuation result and so forth.

3. The allowance calculation program according to claim 1, wherein the allowance to be paid to each valuatee is displayed on the screen of a computer.

4. An allowance calculation program to be processed with a personal computer such as to obtain reflection of the personal valuation result on the calculation of the allowance such as the wage based on job valuation, the bonus, the annual salary and so forth, wherein:
the personal computer is programmed such that it functions as:
a first computing means for obtaining the product of the total valuation mark of each valuatee in the personal valuation and the seniority-related value related to the age, the continuous service years and so forth of each valuatee, a second computing means for calculating the tentative allowance based on the sole pertinent term personal valuatee by multiplying the product obtained by the first computing means by the allowance calculation obtained by dividing the total allowance for each of predetermined personal valuation subject groups by the sum of the overall valuation marks, a third computing means for calculating the pertinent term allowance change by multiplying the difference between the tentative allowance and the past allowance by the ratio between the past total allowance and the pertinent term total allowance, and a forth computing means for calculating the allowance for each valuatee by adding the pertinent term allowance change to the past total allowance.
